(19) United States
(12) Patent Application Publication
(10) Pub. No.: US 2018/0192363 A1
(43) Pub. Date: Jul. 5, 2018

(54) A server and mobile device for optimum radio access technology

(71) Applicant: Siptronix Oy, Oulu (FI)

(72) Inventor: Petteri Holma, Oulu (FI)

(21) Appl. No.: 15/740,829

(22) PCT Filed: Jun. 22, 2016
(86) PCT No.: PCT/FI2016/050452

§ 371 Date: Dec. 29, 2017

(30) Foreign Application Priority Data
Jul. 3, 2015 (FI) 20155532

(51) Int. Cl. H04W 48/18; H04W 8/18

(52) U.S. Cl. CPC H04W 48/18; H04W 8/18

(57) ABSTRACT

The present invention concerns a method and system for ensuring that a minimum required access technology condition is met in a mobile device. The preferred access technologies are selected by a server infrastructure. If the active subscription in a mobile device cannot connect to network using any of the preferred access technologies, the subscription belonging to the next preferred subscription profile is selected by the mobile device, and a report signal is transmitted to the server infrastructure. This procedure continues until a subscription can connect to network using one of the preferred access technologies, or a subscription belonging to the least preferred subscription profile is selected. Similarly, when the mobile device changes the cell, a report signal is sent to the server infrastructure and the server infrastructure performs a check using a poor profiles list whether a more preferred subscription should be selected in the current location of the mobile device. If the more preferred subscription should be selected, the server infrastructure sends a signal to the mobile device in order to select the more preferred subscription.

### TECHNICAL FIELD OF THE INVENTION

The present invention relates to a server and mobile device in telecommunications network.

The present invention also relates devices for collecting and storing data in telecommunications system.

More particularly, the present invention is directed to a method and system for ensuring that a minimum required access technology condition is met in a mobile device.

### BACKGROUND OF THE INVENTION

The invention is directed to mobile devices including multi-IMSI SIM-cards.

The invention was made because of growing need from various industry verticals for high-quality mobile data services, ensured by multiple subscriptions.

In the prior art the subscriptions can be remotely downloaded from the IP network based service to SIM cards. Also the SIM cards may contain at the same time several subscriptions from different mobile network operators, one subscription being active at time. When the subscription already exists on a SIM card, it can be set active by a command initiated from a server connected to IP network.

In the prior art it is assumed that a local subscription is chosen whenever the network of a local mobile operator is available. If the network of a local mobile operator is not available, the predefined default subscription is chosen, which may be a roaming subscription.

The prior art does not describe any data collecting method or system optimizing access technology for mobile devices especially in such accuracy that base station location data of another operators, than operator of the active subscription (IMSI), would be used in this context.

EP 2 282 586 describes a multi-RAT capable wireless device and a method for execution in a multi-RAT capable wireless device are provided. The wireless device maintains a registration history of all wireless networks.

US 2013/0204959 A1 describes systems and methods of performing real-time data subscription and reporting for telecommunications systems and devices. The systems and methods employ a real-time data aggregation component that can manage subscription requests for real-time data objects stored on the telecommunications systems and devices from one or more users over a network, dynamically start and stop such subscription requests, cache the requested real-time data objects, and supply the real-time data to the respective users.

US 2013/0150067 A1 teaches that a cellular communications system may include a plurality of mobile cellular communications devices each associated with a respective user, and at least one cellular base station for wirelessly communicating with the mobile cellular communications devices. The at least one cellular base station may have a capacity associated therewith. The system may also include a central station for determining available capacity of the at least one cellular base station based upon active wireless communications with the mobile cellular communications devices. Moreover, the system may also include a subscription server for cooperating with the central station to provide non-real time subscription data to users on respective mobile cellular communications devices via the at least one cellular base station when the determined available capacity thereof is greater than a threshold.

US 2004/0078274 A1 discloses a system and a method of providing on-line subscription services from a subscription server to a user of a mobile terminal through the internet. The subscription server receives from the mobile terminal user-specific information relating to the user's mobile terminal capabilities, the user's preference of products, and the user's financial information.

US 2013/0007853 A1 teaches a mobile device and method for automatic connectivity, data offloading and roaming between networks. Embodiments of a mobile device and methods automatically connecting to a Wi-Fi Hotspot 2.0 are generally described herein. In some embodiments, subscription information for one or more service providers (SP) that operate Wi-Fi networks is stored in a subscription data object of the mobile device. The subscription information includes home service provider information, policy information and pre-provisioned credentials. The mobile device may be configured to determine, without user interaction, if the subscription information is applicable to an available Wi-Fi network and perform without user interaction, an extensible authentication protocol (EAP) based authentication using the pre-provisioned credentials with the available Wi-Fi network to establish a Wi-Fi connection with the available Wi-Fi network. This automatic connectivity may allow a mobile device to roam across Wi-Fi hotspots of Wi-Fi networks and offload traffic to Wi-Fi networks.

US 2011/0294505 A1 discloses methods, systems, and products for terminal registration with a base station. Aspects of the invention include a method for dynamically performing subscription registration. A method includes pre-storing complete subscription data into a base station; predefining general subscription data in a mobile terminal; initiating, from the terminal, a location registration when within the radio range of the base station, wherein the terminal does not contain complete subscription data, but does contain general subscription data; authorizing the terminal in dependence upon the pre-stored subscription data; and, upon successful authorization, modifying the subscription data in the terminal to correspond to the complete subscription data.

US 2010/0041438 A1 describes a multiple subscription subscriber identity module (SIM) card. The SIM card includes a plurality of sets of subscription parameters from which to select and activate a single set of parameters. The sets of subscription parameters each contain various information, e.g., information such as an Integrated Circuit Card Identifier (ICCID) and an International Mobile Subscriber Identity (IMSI), and are based on various criteria, e.g., different service regions of use for the electronic device on which the SIM card is installed. A set of subscription parameters is selected for a particular region of use either manually or automatically. The SIM card, which can include a software interface that provides a list of available sets of subscription parameters, is activated by updating the selected set of subscription parameters. Alternatively, a default set of subscription parameters is selected unless a different set of subscription parameters is selected manually from among the plurality of sets of subscription parameters. According to alternative embodiments of the invention, the selected set of subscription parameters can be deactivated and a different set of subscription parameters can be selected and updated to in the SIM card.

### SUMMARY OF THE INVENTION

The present invention concerns a method and system for ensuring that a minimum required access technology condition is met in a mobile device. The preferred access technologies are selected by a server infrastructure. If the active subscription in a mobile device cannot connect to network using any of the preferred access technologies, the subscription belonging to the next preferred subscription profile is selected by the mobile device, and a report signal is transmitted to the server infrastructure. This procedure continues until a subscription can connect to network using one of the preferred access technologies, or a subscription belonging to the least preferred subscription profile is selected. Similarly, when the mobile device changes the cell, a report signal is sent to the server infrastructure and the server infrastructure performs a check using a poor profiles list whether a more preferred subscription should be selected in the current location of the mobile device. If the more preferred subscription should be selected, the server infrastructure sends a signal to the mobile device in order to select the more preferred subscription.

These and other objects are achieved by the present invention, as hereinafter described and claimed. Thus the invention concerns a mobile device comprising at least one processing core, at least one memory including computer program code, the at least one memory and the computer program code being configured to, with the at least one processing core, cause the mobile device to: connect to the telecommunications network with at least two subscriptions, send location corresponding the change, include a set of preferred access technologies, receive an access technology change event in order to identify a new access technology check if the access technology belongs to the set of preferred access technologies, and if true end the session, if false check if the next preferred subscription is available and related network supports preferred access technology in the current location, until an available preferred subscription supporting the preferred access technology is found, switch from active subscription to the preferred subscription meeting the subscriber profile according to the predetermined list stored in the mobile device (20), report information of the subscription switch and previous and current access technologies together with the current IMSI, MCC, MNC, LAI and cell id to the server, and if no subscription meeting the condition is found end the session.

The invention concerns also a server connected to a telecommunications network comprising at least one processing core, at least one memory including computer program code, the at least one memory and the computer program code being configured to, with the at least one processing core, cause the server to be in connection with a mobile device being capable to be in connect to the telecommunications network with at least two mobile subscriptions (IMSI), receive and store information from the mobile device relating to of preferred access technologies of at least one of the at least two subscriptions based on the location data of the mobile device, form databases of received information for cell tower information, subscription profile information and poor profile information, which consists of many-to-many mapped data between the cell tower database and the subscription profile database.

The invention concerns also a server connected to a telecommunications network comprising at least one processing core, at least one memory including computer program code, the at least one memory and the computer program code being configured to, with the at least one processing core, cause the server to connect the mobile device is to a telecommunications network with at least two active subscriptions receive a report from the mobile device by a server, the report including at least one of the following; a location change event, a new location, network access technology and a subscription (IMSI), check if the subscription belongs to the most preferred subscription profile in the given location, and if true send updated list of available access technologies to the mobile device as they are available for each subscription in the current location based on poor profile information stored in server, and if the subscription does not belong to the most preferred subscription profile in the given location, find a more preferred subscription profile and check that it does not belong in the current location (cell) to the poor profiles list formed from a many-to-many mapped table on server (10) formed from a cell tower database and subscription profile database, and if true download and switch to the mobile device an belonging to the more preferred subscription profile in the mobile device and receive a response from the mobile device and store information to the server, if not true send updated list of available access technologies to the mobile device as they are available for each subscription in the current location based on poor profiles list stored in server and end the session.

The invention concerns also a mobile device comprising at least one processing core, at least one memory including computer program code, the at least one memory and the computer program code being configured to, with the at least one processing core, cause the mobile device to connect to a telecommunications network with at least two active subscriptions, report upon a location change event a new location, network access technology and IMSI to a server in the telecommunications network, receive an updated list of available access technologies to the mobile device as they are available for each subscription in the current location based on poor profiles list stored in server, if commanded execute the command received from the server and report back to server when switch completed together with information of the current radio access technology.

The telecommunications network is in one embodiment of the invention a mobile telephone network.

In some embodiments of the invention the mobile device and the server support at least the following access technologies: GSM and EDGE, UTRAN (3G) and E-UTRAN (also LTE or 4G).

The server infrastructure is preferably including an information server and a database server which are connected to each other via a network such as an IP network, or are integrated into one server infrastructure, or are separated.

The at least one mobile device is preferably including at least one processor with at least one core, a memory, a subscription identity module, a battery, and a network interface including a transceiver to communicate with the server infrastructure over the mobile communications network.

The at least one mobile device is preferably including a user interface including a display and an input device such as a keyboard and/or touchscreen.

Considerable advantages are obtained by means of the present invention. The methods, apparatuses and systems of the present invention provide the following key advantages in some of its embodiments: the best access technology may be provided to mobile devices like mobile phones at any location.

### BRIEF DESCRIPTION OF THE DRAWINGS

For a more complete understanding of particular embodiments of the present invention and their advantages, reference is now made to the following descriptions, taken in conjunction with the accompanying drawings. In the drawings:

FIG. 1 illustrates a schematic view of a configuration of a system according to an embodiment of the present invention and an arrangement of mobile device, server and related database in the system,

FIG. 2A illustrates a schematic view of an arrangement of a mobile device (e.g. connected consumer electronics device, mobile phone or laptop PC) in accordance with one embodiment of the invention,

FIG. 2B illustrates a schematic view of an arrangement of a mobile device (e.g. connected consumer electronics device, mobile phone or laptop PC) in accordance with one embodiment of the invention,

FIG. 3 illustrates a schematic view of an arrangement of a server, and

FIG. 4 illustrates a flow chart of steps collecting data into the server for the present invention.

FIG. 5 illustrates a flow chart of steps for using the data collected in the server.

### DETAILED DESCRIPTION OF EMBODIMENTS OF THE INVENTION

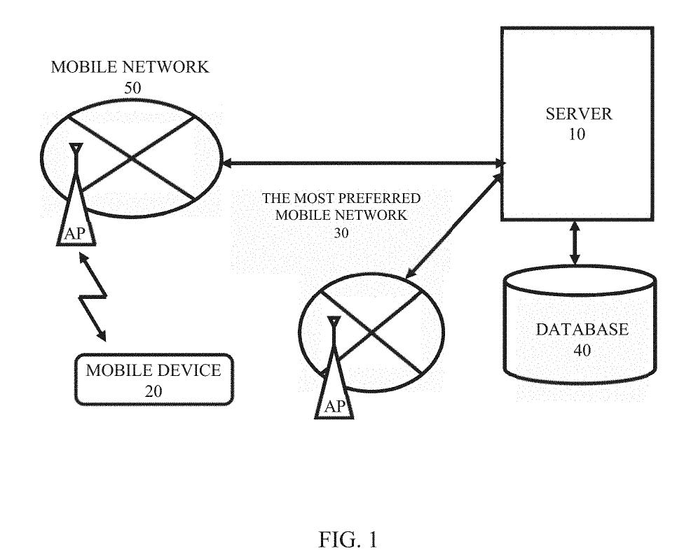

In FIG. 1 an example of a configuration of mobile service according to one embodiment of the present invention, and an arrangement of a mobile device 20 forming part of the system is shown. In FIG. 1, the mobile device 20 is connected to a mobile communications network 50. The mobile communications network 50 and the most preferred wireless network 30 are connected to a server infrastructure 10 of a service provider including all necessary functionalities like a database and one or more processors each with one or more cores.

The server 10 may have functionalities, which sometimes are distributed as independent servers like information servers and/or database server or database 40 connected to each other via a network, e.g. an IP network. Service provider may be thought of as the mainframe linking all servers. By number 30 is referred to the most preferred wireless network of the mobile device 20 at a given time and a location.

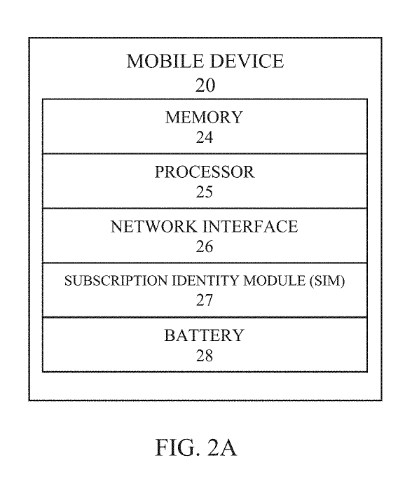

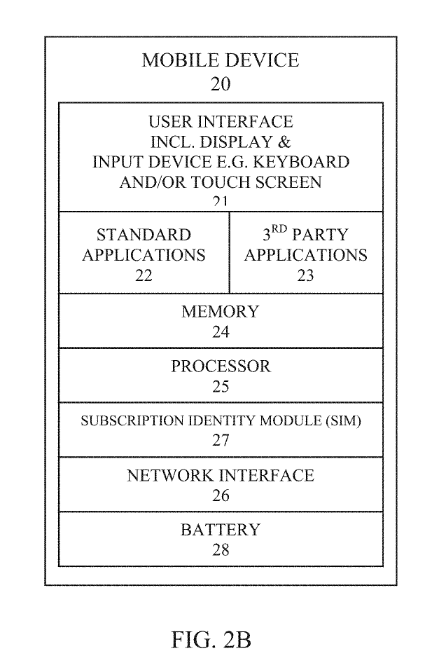

FIG. 2A and FIG. 2B show two different arrangements of a mobile device 20. The mobile device 20 includes always a processor 25 with one or more cores, a memory device 24, a subscription identity module (SIM) 27, a battery 28 and a network interface 26 including a transceiver to communicate with the service provider over the mobile communications network 50. A mobile device may also include a user interface 21 including a display and an input device (e.g. keyboard).

The subscription identity module (SIM) 27 is used to store mobile subscriptions. Mobile subscriptions may be remotely loaded (and unloaded) by the service provider to subscription identity modules 27.

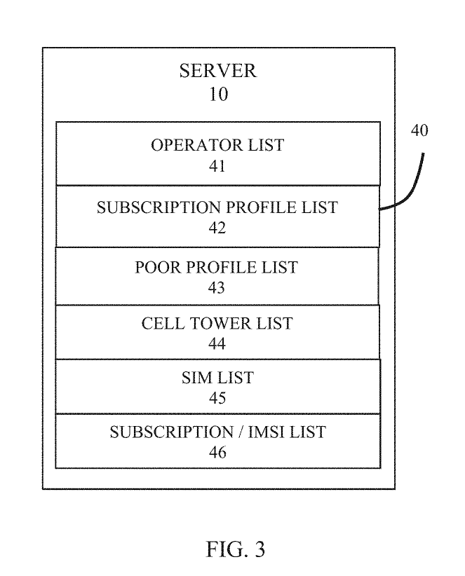

FIG. 3 shows an example of a server 10 including in a database 40 a list for operators 42, a list for subscription profiles 42, a list for poor profiles 43, a list for cell towers 44, a list for SIMs 45 and a list for subscriptions/IMSIs 46. The server 10 includes at least one processor with at least one core.

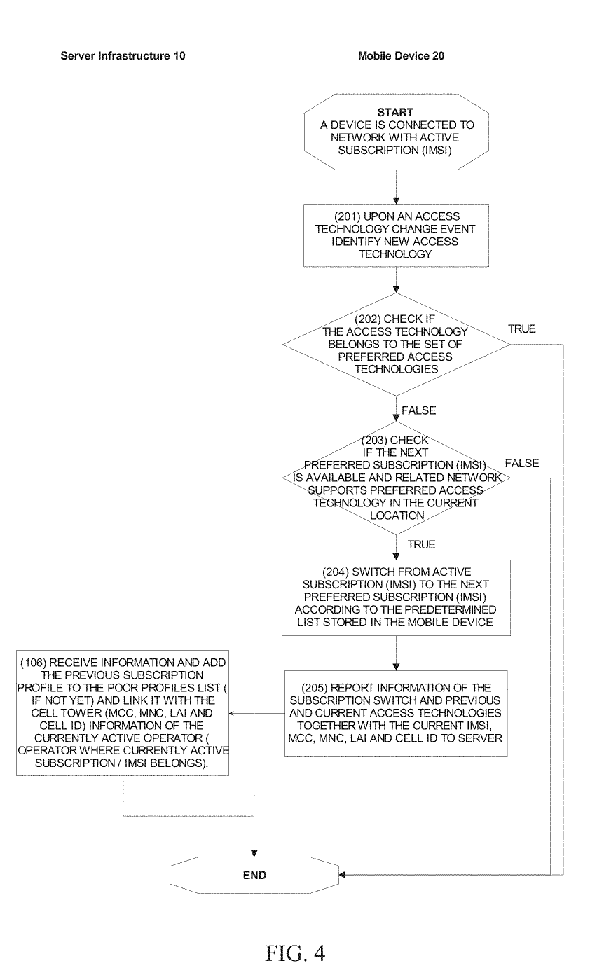

FIG. 4 shows an exemplary flow chart of the program executed by the server 10 or mobile device 20 in order to collect data from the network 50 in the following way:

A mobile device 20 comprising at least one processing core 25, at least one memory 24 including computer program code, the at least one memory 24 and the computer program code being configured to, with the at least one processing core 25, cause the mobile device 20 to connect to a telecommunications network 50 with at least one of at least two available subscriptions (IMSI) Further the mobile device is able to include a set of preferred access technologies in the memory 24 or SIM 27 of the mobile device 20, receive 201 an access technology change event in order to identify a new access technology, check 202 if the access technology belongs to the set of preferred access technologies, and if true end the session, if false check 203 if the next preferred subscription (IMSI) is available and related network supports preferred access technology in the current location. The current location means typically in this application coverage area of the cell tower the mobile device is connected to. The process continues process until an available preferred subscription (IMSI) supporting the preferred access technology is found, switch 204 from active subscription (IMSI) to the preferred subscription (IMSI) meeting the subscriber profile according to the predetermined list stored in the mobile device 20. Then the mobile device 20 reports 205 information of the subscription switch and previous and current access technologies together with the current IMSI, MCC, MNC, LAI and cell id to the server 10, and if no subscriptions (IMSI) meeting the condition is found the mobile device ends the session.

Typically the telecommunications network 50 is a mobile telephone network.

Typically the telecommunications network, server 10 and the mobile device support at least two of the following access technologies: GSM and EDGE, UTRAN (3G) and E-UTRAN (also LTE or 4G) or corresponding technologies in TDMA or CDMA.

In accordance with FIG. 4 the server 10 connected to a telecommunications network 50 comprises at least one processing core, at least one memory including computer program code, the at least one memory and the computer program code being configured to, with the at least one processing core. The server 10 is able to be in connection with a mobile device 20 being capable to be in connect to the telecommunications network with at least two mobile subscriptions (IMSI), receive 106 and store information from the mobile device 20 relating to of preferred access technologies of at least one of the at least two subscriptions based on the location data of the mobile device, form databases 40 of received information for cell tower information 44 and subscription profile information 46, and poor profile information, which consists of many-to-many mapped data between the cell tower database 44 and the subscription profile database 46.

typically the telecommunications network 50 is a mobile telephone network.

Typically at least two of following access technologies are supported: GSM and EDGE, UTRAN (3G) and E-UTRAN (also LTE or 4G) or corresponding technologies in TDMA or CDMA.

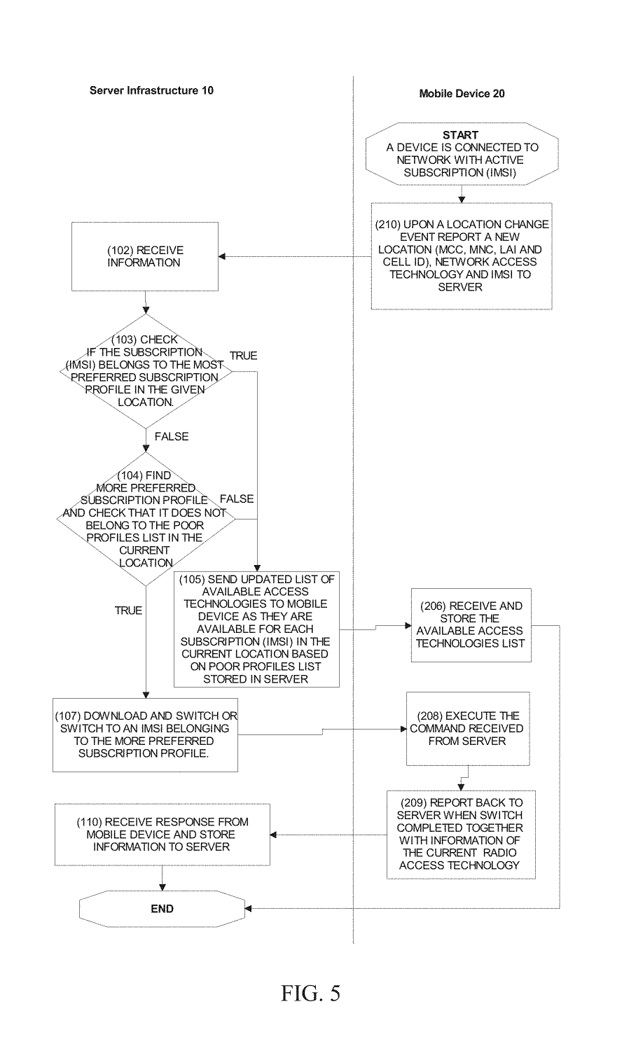

In accordance with FIG. 5 a server 10 is connected to a telecommunications network comprising at least one processing core, at least one memory including computer program code, the at least one memory and the computer program code being configured to, with the at least one processing core. The server is capable connect the mobile device 20 is to a telecommunications network with at least two active subscriptions (IMSI), receive 102 a report from the mobile device 20 by a server 10, the report including at least one of the following; a location change event, a new location (MCC, MNC, LAI and cell id), network access technology and a subscription (IMSI), check 103 if the subscription (IMSI) belongs to the most preferred subscription profile in the given location, and if true send 105 updated list of available access technologies to the mobile device 20 as they are available for each subscription (IMSI) in the current location based on poor profiles list stored in server 10, and if the subscription (IMSI) does not belong to the most preferred subscription profile in the given location, find 104 a more preferred subscription profile and check that it does not belong in the current location to the poor profiles list formed from a many-to-many mapped table on server 10 formed from a cell tower database and subscription profile database, and if true download 107 and switch to the mobile device 20 an IMSI belonging to the more preferred subscription profile in the mobile device 20 and receive 110 a response from the mobile device 20 and store information to the server 10, if not true send 105 updated list of available access technologies to the mobile device (20) as they are available for each subscription (IMSI) in the current location based on poor profiles list stored in server 10 and end the session.

A mobile device 20 comprising at least one processing core, at least one memory including computer program code, the at least one memory and the computer program code being configured to, with the at least one processing core, cause the mobile device to connect to a telecommunications network 50 with at least one of at least two available subscriptions (IMSI), report 210 upon a location change event a new location (MCC, MNC, LAI and cell id), network access technology and IMSI to a server 10 in the telecommunications network, receive 105 an updated list of available access technologies to the mobile device 20 as they are available for each subscription (IMSI) in the current location based on poor profiles list stored in server 10, if commanded execute 208 the command received from the server 10 and report 209 back to server 10 when switch completed together with information of the current radio access technology.

Subscription profile defines subscriptions with similar characteristics belonging to one mobile operator.

Within one mobile operator there can be several different subscription profiles. E.g. subscriptions which have 4G access technology enabled could belong to one subscription profile, while subscriptions which can't use 4G access technology could belong to another.

Each subscription (IMSI) belong to one subscription profile. Set of preferred access technologies defines all access technologies which mobile device should use if any of them are available in the present location of a device. If none of the preferred access technologies are available in the location of the mobile device as a result of the procedure described in FIG. 4, a subscription belonging to the least preferred subscription profile present in the mobile device is chosen. The set of preferred access technologies can be updated in mobile device remotely.

The set of preferred access technologies herein is meant to be a device specific list and not only subscription specific list as it could be too. It is already known that when a mobile device is connected to a network it can search and choose a more preferred access technology.

This can be done e.g. by setting HPLMNwACT, PLMNwACT or OPLMNwACT lists to SIM so that the most preferred access technology and related PLMN network is top most.

Poor profiles list, which is one embodiment of this invention together with its information gathering, information utilizing and dynamic update mechanisms, maps such subscription profiles to cell towers, which cannot use any of the preferred access technologies in the area of a cell tower.

The mapping of a subscription profile is done to a cell tower of a different operator than where the subscription profile belongs as shown in FIG. 4/106, because by that way it is possible to detect on server side as shown in FIG. 5/105 when it is feasible to send a subscription profile switch command to a mobile device in order to switch back to a more preferred subscription. Because the mapping is done on the subscription profile level and not on the subscription level, the information that is gathered as a result of the procedure shown in FIG. 4 can be utilized on the system wide with all devices having subscriptions which belong to the same subscription profile.

In accordance with ETSI standard the access technologies are the following from the slowest to the fastest:

GSM based networks:
GSM and EDGE, (slowest),
UTRAN (3G) and
E-UTRAN (also LTE or 4G)(fastest)
CDMA networks

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in telecommunications and telecommunications networks.

### Acronyms List

SIM subscription identity module
IMSI international mobile subscription identity
MCC mobile country code
MNC mobile network code
LAI location area information
GSM global system for mobile communications
EDGE enhanced data GSM environment
2G generic term for second generation radio access technologies (e.g. GSM/EDGE)
UTRAN UMTS terrestrial radio access network
3G generic term for third generation radio access technologies (e.g. UTRAN)
E-UTRAN evolved UMTS terrestrial radio access network
LTE long term evolution (radio access part of E-UTRAN)
4G generic term for fourth generation radio access technologies (e.g. E-UTRAN/LTE)

### LIST OF REFERENCE NUMBERS

10 server infrastructure
20 mobile device
21 user interface
22 standard applications
23 3^{rd} party applications
24 memory
25 processor
26 network interface
27 subscription identity module (SIM)
28 battery
30 wireless network
41 operator list
42 subscription profile list
43 poor profile list
44 cell tower list
45 sim list
46 subscription/IMSI list
50 mobile communications network
40 database
90 activity point
102 RECEIVE INFORMATION
103 CHECK IF THE SUBSCRIPTION (IMSI) BELONGS TO THE MOST PREFERRED SUBSCRIPTION PROFILE IN THE GIVEN LOCATION.
104 FIND MORE PREFERRED SUBSCRIPTION PROFILE AND CHECK THAT IT DOES NOT BELONG TO THE POOR PROFILES LIST IN THE CURRENT LOCATION
105 SEND UPDATED LIST OF AVAILABLE ACCESS TECHNOLOGIES TO MOBILE DEVICE AS THEY ARE AVAILABLE FOR EACH SUBSCRIPTION (IMSI) IN THE CURRENT LOCATION BASED ON POOR PROFILES LIST STORED IN SERVER
106 RECEIVE INFORMATION AND ADD THE PREVIOUS SUBSCRIPTION PROFILE TO THE POOR PROFILES LIST (IF NOT YET) AND LINK IT WITH THE CELL TOWER (MCC, MNC, LAI AND CELL ID) INFORMATION OF THE CURRENTLY ACTIVE OPERATOR (OPERATOR WHERE CURRENTLY ACTIVE SUBSCRIPTION/IMSI BELONGS).
107 DOWNLOAD AND SWITCH OR SWITCH TO AN IMSI BELONGING TO THE MORE PREFERRED SUBSCRIPTION PROFILE.
110 RECEIVE RESPONSE FROM MOBILE DEVICE AND STORE INFORMATION TO SERVER
201 UPON AN ACCESS TECHNOLOGY CHANGE EVENT IDENTIFY NEW ACCESS TECHNOLOGY
202 CHECK IF THE ACCESS TECHNOLOGY BELONGS TO THE SET OF PREFERRED ACCESS TECHNOLOGIES
203 CHECK IF THE NEXT PREFERRED SUBSCRIPTION (IMSI) IS AVAILABLE AND RELATED NETWORK SUPPORTS PREFERRED ACCESS TECHNOLOGY IN THE CURRENT LOCATION
204 SWITCH FROM ACTIVE SUBSCRIPTION (IMSI) TO THE NEXT PREFERRED SUBSCRIPTION (IMSI) ACCORDING TO THE PREDETERMINED LIST STORED IN THE MOBILE DEVICE
205 REPORT INFORMATION OF THE SUBSCRIPTION SWITCH AND PREVIOUS AND CURRENT ACCESS TECHNOLOGIES TOGETHER WITH THE CURRENT IMSI, MCC, MNC, LAI AND CELL ID TO SERVER
206 RECEIVE AND STORE THE AVAILABLE ACCESS TECHNOLOGIES LIST
208 EXECUTE THE COMMAND RECEIVED FROM SERVER
209 REPORT BACK TO SERVER WHEN SWITCH COMPLETED TOGETHER WITH INFORMATION OF THE CURRENT RADIO ACCESS TECHNOLOGY
210 UPON A LOCATION CHANGE EVENT REPORT A NEW LOCATION (MCC, MNC, LAI AND CELL ID), NETWORK ACCESS TECHNOLOGY AND IMSI TO SERVER

1. A mobile device comprising at least one processing core, at least one memory including computer program code, the at least one memory and the computer program code being configured to, with the at least one processing core, cause the mobile device to:
connect to a telecommunications network with at least one of at least two available subscriptions (IMSI),
include a set of preferred access technologies in the memory or SIM of the mobile device,
receive an access technology change event in order to identify a new access technology,
check if the access technology belongs to the set of preferred access technologies, and if true end the session,
if false check if the next preferred subscription (IMSI) is available and related network supports preferred access technology in the current location, until an available preferred subscription (IMSI) supporting the preferred access technology is found,
switch from active subscription (IMSI) to the preferred subscription (IMSI) meeting the subscription profile according to the predetermined list stored in the mobile device,
report mobile device identity (e.g. IMSI) and current location to the server,
if no subscriptions (IMSI) meeting the condition is found end the session.

2. The mobile device according to claim 1, wherein the telecommunications network is a mobile telephone network.

3. The mobile device according to claim 1 wherein it supports at least two of the following access technologies: GSM and EDGE, UTRAN (3G) and E-UTRAN (also LTE or 4G) or corresponding technologies in TDMA or CDMA.

4. A server connected to a telecommunications network comprising at least one processing core, at least one memory including computer program code, the at least one memory and the computer program code being configured to, with the at least one processing core, cause the server to:
be in connection with a mobile device being capable to be in connection to the telecommunications network with at least one of at least two available mobile subscriptions (IMSI),
receive and store information from the mobile device relating to of available access technologies of at least one subscription based on the location of the mobile device,
form poor profile information from the received information, the poor profile information consists of mapping between cell tower information and subscription profile information.

5. A server connected to a telecommunications network comprising at least one processing core, at least one memory including computer program code, the at least one memory and the computer program code being configured to, with the at least one processing core, cause the server to:
connect the mobile device to a telecommunications network with at least one of at least two available subscriptions (IMSI),
receive a report from the mobile device by a server, the report including at least identification of the mobile device and information of an event, and
check if the subscription (IMSI) belongs to the most preferred subscription profile in the given location, and
if the subscription (IMSI) does not belong to the most preferred subscription profile in the given location, find a more preferred subscription profile and check that it does not belong in the current location to the poor profiles list, and
if true enable an IMSI in the mobile device, which belongs to the more preferred subscription profile in the mobile device, and receive a response from the mobile device and store information to the server

6. The server according to claim 5, wherein the at least one memory and the computer program code are further configured to, with the at least one processing core, cause the server to check if the subscription (IMSI) belongs to the most preferred subscription profile in the given location, and if true an updated list of available access technologies to the mobile device as they are available for any or each subscription (IMSI) in the current location based on poor profiles list stored in server.

7. The server according to claim 5, wherein the at least one memory and the computer program code are further configured to, with the at least one processing core, cause the server to check if the subscription (IMASI) belongs to the most preferred subscription profile in the given location and if not true an updated list of available access technologies to the mobile device as they are available for each or any subscription (IMSI) in the current location based on poor profiles list stored in server and end the session.

8. A mobile device comprising at least one processing core, at least one memory including computer program code, the at least one memory and the computer program code being configured to, with the at least one processing core, cause the mobile device to:
connect to a telecommunications network with at least one of at least two available subscriptions (IMSI),
report upon a location change event a mobile device identification (e.g. IMSI) and a new location to a server in the telecommunications network, and
if IMSI switch commanded execute the command received from the server and report back to server when switch completed.

9. The mobile device according to claim 8, wherein it is capable to receive an updated list of available access technologies to the mobile device as they are available for each or any subscription (IMSI) in the current location based on poor profiles list stored in server (10).

10. The mobile device according to claim 8, wherein the telecommunications network is a mobile telephone network.

11. The mobile device according to claim 8, wherein it supports at least two of the following access technologies: GSM and EDGE, UTRAN (3G) and E-UTRAN (also LTE or 4G) or corresponding technologies in TDMA or CDMA.
